(19) United States
(12) Patent Application Publication
(10) Pub. No.: US 2003/0193630 A1
(43) Pub. Date: Oct. 16, 2003

(54) Light guide plate capable of controlling light-emitting angle and liquid crystal display therewith

(75) Inventor: Yi-Shiuan Chiou, Taipei (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU OPTRONICS CORP.

(21) Appl. No.: 10/375,871

(22) Filed: Feb. 21, 2003

(30) Foreign Application Priority Data
Apr. 10, 2002 (TW) 91107222

(51) Int. Cl. G02F 1/1335

(52) U.S. Cl. 349/65

(57) ABSTRACT

A light guide plate capable of controlling light-emitting angle. The light guide plate includes a plurality of recesses or protrusions, each recess or protrusion including a main axis, a circular plane perpendicular to the main axis, an arc lateral plane formed by an arc from a first included angle to a second included angle in respect to the main axis at a predetermined radius surrounding the main axis, wherein an edge of the arc lateral plane is connected to an edge of the circular plane, and a reflective film formed over the circular plane and the arc lateral plane. The light-emitting angle of the light guide plate is regulated by the first and second included angles, thereby increasing view angle of a liquid crystal display device.

### BACKGROUND OF THE INVENTION

1. Field of the Invention

The invention relates to a light guide plate capable of controlling light-emitting angle, particularly to utilization of the light guide plate capable of controlling light-emitting angle for a liquid crystal display (LCD) to increase viewing angle of the LCD.

2. Description of the Related Art

FIG. 1 is a schematic diagram of a typical liquid crystal display (LCD) device. In FIG. 1, the LCD includes: a light guide plate 1, a lamp 2 located by an end 1a of the light guide plate 1, a diffusing means 3 located over a plane 1b of the light guide plate 1, a reflective sheet 4 located on another plane 1c of the light guide plate 1 and a liquid crystal panel 5.

As shown in FIG. 1, when the lamp 2 lights, light from the lamp 2 illuminates the plate 1. Light from the plate 1 is fully reflected or reflected by the reflective sheet 4 to the diffusing means 3. Thus, light uniformly illuminates the liquid crystal panel 5 through the diffusing means 3.

Viewing angle of the typical LCD device is commonly controlled by the structures of the diffusing means and the liquid crystal panel. A means of controlling viewing angle of a liquid crystal display device by adjustment of the light guide plate of the LCD has not been disclosed.

### SUMMARY OF THE INVENTION

Accordingly, an object of the invention is to provide a light guide plate capable of controlling light-emitting angle having a plurality of recesses on a plane adjacent to a reflector. Each recess includes: a main axis; an arc lateral plane formed by an arc from a first included angle to a second included angle in respect to the main axis at a predetermined radius surrounding the main axis; and a circular plane adjacent to the arc lateral plane. Additionally, each recess includes a reflective sheet to adjust the ranges of the first and second included angles so as to regulate the light-emitting angle of the light guide plate.

Another object of the invention is to provide a light guide plate capable of controlling light-emitting angle having a plurality of protrusions. Each protrusion includes: a main axis; an arc lateral plane formed by an arc from a first included angle to a second included angle in respect to the main axis at a predetermined radius surrounding the main axis; and a circular plane adjacent to the arc lateral plane. Additionally, each protrusion includes a reflective sheet to adjust the ranges of the first and second included angles so as to regulate the light-emitting angle of the light guide plate.

A further object of the invention is to provide an LCD, including a liquid crystal panel, a light guide plate capable of controlling light-emitting angle, a lamp and a reflector. A plurality of recesses are formed on a plane of the light guide plate adjacent to the reflector. Each recess includes: a main axis; an arc lateral plane formed by an arc from a first included angle to a second included angle in respect to the main axis at a predetermined radius surrounding the main axis; and a circular plane adjacent to the arc lateral plane. Additionally, each recess includes a reflective sheet to adjust the ranges of the first and second included angles so as to regulate the light-emitting angle of the light guide plate and further regulate viewing angle of the LCD.

Still another object of the invention is to provide a liquid crystal display, including a liquid crystal panel, a light guide plate capable of controlling light-emitting angle, a lamp, and a reflector. A plurality of protrusions are formed on a plane of the light guide plate adjacent to the reflector. Each protrusion includes: a main axis; an arc lateral plane formed by an arc from a first included angle to a second included angle in respect to the main axis at a predetermined radius surrounding the main axis; and a circular plane adjacent to the arc lateral plane. Additionally, each recess includes a reflective sheet to adjust the ranges of the first and second included angles so as to regulate the light-emitting angle of the light guide plate and further regulate viewing angle of the LCD.

A characteristic of this invention is its regulation of the ranges of the first and second angles for each recess so as to control the light-emitting angle of the light guide plate.

Another characteristic of this invention is its regulation of the ranges of the first and second included angles for each protrusion so as to regulate viewing angle of the LCD.

An advantage of this invention is its replacement of the typical diffusing means with the light guide plate with one featuring a controllable light-emitting angle.

Another advantage of this invention is utilization of the light guide plate capable of controlling light-emitting angle to reduce LCD thickness.

### BRIEF DESCRIPTION OF THE DRAWINGS

The aforementioned objects, features and advantages of this invention will become apparent by referring to the following detailed description of a preferred embodiment with reference to the accompanying drawings, wherein:

FIG. 1 is a schematic diagram of a typical liquid crystal display device;

FIG. 2 is a schematic cross-section of a light guide plate capable of controlling light-emitting angle according to a first embodiment of the invention;

FIG. 3 is a schematic diagram showing light-emitting angles of the light guide plate according to the first embodiment of the invention;

FIG. 4 is a schematic diagram showing an LCD with the light guide plate capable of controlling light-emitting angle of FIG. 2 according to the invention;

FIG. 5 a schematic cross-section of a light guide plate capable of controlling light-emitting angle according to a second embodiment of the invention; and

FIG. 6 is a schematic diagram showing an LCD with the light guide plate capable of controlling light-emitting angle of FIG. 5 according to the invention.

### DETAILED DESCRIPTION OF THE INVENTION

[First Embodiment]

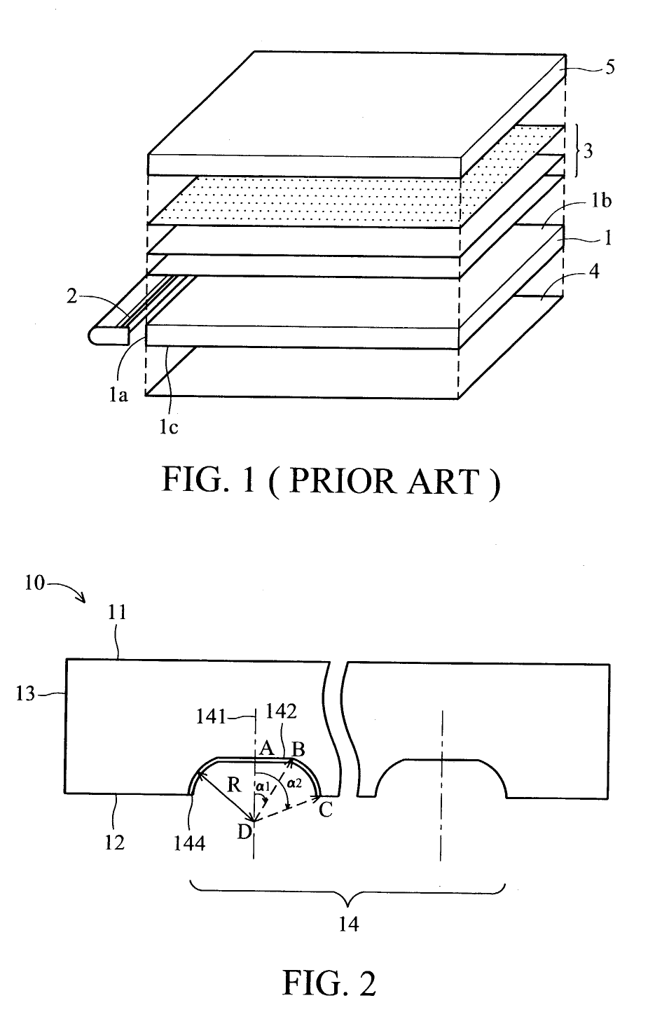

FIG. 2 is a schematic cross-section of a light guide plate capable of controlling light-emitting angle according to a first embodiment of the invention. In FIG. 2, the light guide plate capable of controlling light-emitting angle 10 has a light-emitting plane 11 and a light-reflecting plane 12. Additionally, a lamp is disposed near to an end 13 of the light guide plate 10. The invention is characterized by formation of a plurality of reflective patterns 14 on the light reflection plane 12.

As shown in FIG. 2, a plurality of reflective patterns 14 are a plurality of recesses. Each recess includes a main axis 141 and a circular plane 142 perpendicular to the main axis 141. Additionally, an arc from a first included angle al to a second included angle α2 in respect to the main axis 141 at a predetermined radius R is formed and an arc lateral plane 143 is formed by the arc around the main axis 141. An edge of the arc lateral plane 143 at the first included angle α1 is also connected to an edge of the circular plane 142. Further, a reflective film 144 on each recess plane is formed over the planes 142, 143 to reflect light in a respective recess.

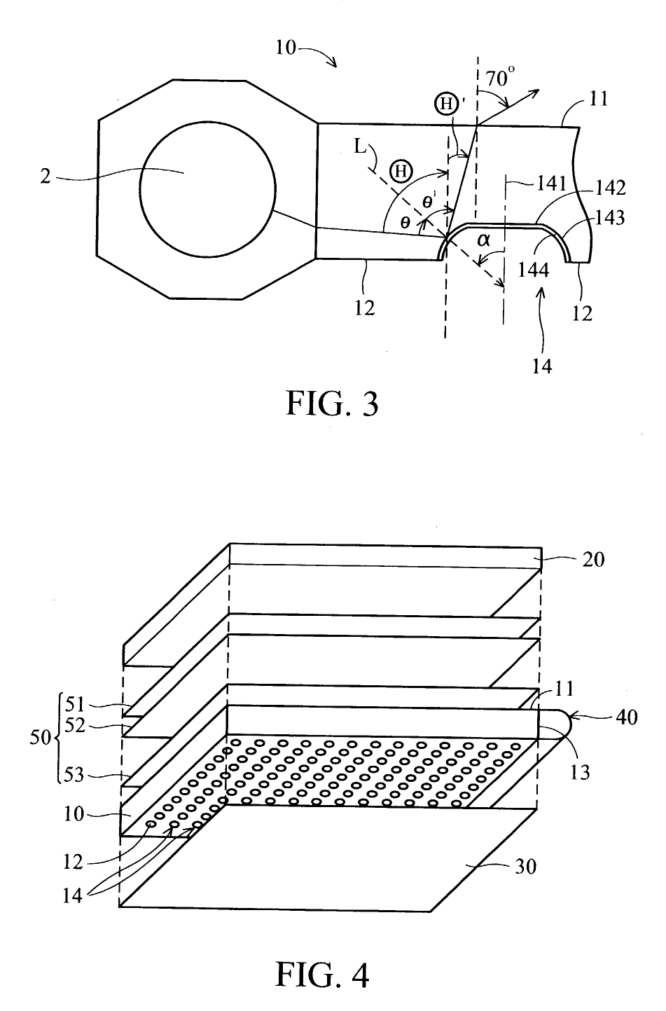

FIG. 3 is a schematic diagram showing light-emitting angles of the light guide plate. In this embodiment, when the lamp 2 lights, light from the lamp 2 has an illumination range of about ±41.15°. As shown in FIG. 3, a notation Θ represents an included angle from an illuminated point on the plane 143 to the main axis 141 during light emission. The included angle Θ ranges from about 47.85° to about 90°. A notation θ represents an included angle from an illuminated point on the plane 143 to a normal L of the illuminated point on the plane 143. A notation θ′ represents an included angle from a reflection of the illuminated point on the plane 143 to the normal L. A notation Θ′ represents an included angle from the reflection of the illuminated point on the plane 143 to the main axis 141. A notation α represents an included angle from the main angle 141 to the normal L. As cited above, the notations comply with following equations:

θ=Θ−α (1)

Θ′=θ′−α (2)

According to the reflective principle, the incident angle θ is equal to the reflective angle Θ. The equations (1) and (2) become:

Θ′=Θ−2α (3)

where Θ ranges from about 47.85° to about 90°.

Again referring to FIG. 3, when the light guide plate 10 has a light-emitting angle range Φ of ±70° and a refractive index of 1.48, Θ′=±39.4° according to the Snell principle. Further, α can derive from the equation (3) and obtain a range of about 25°-45°. Thus, for each recess, the first included angle is about 25° and the second included angle is about 45°.

FIG. 4 is a schematic diagram showing a liquid crystal display (LCD) with the light guide plate capable of controlling light-emitting angle according to the first embodiment. In FIG. 4, the LCD includes: a liquid crystal panel 20, a light guide plate capable of controlling light-emitting angle 10, a reflector 30, and a lamp 40. Additionally, a diffusing means 50 can be located between the liquid crystal panel 20 and the light guide plate 10 as needed. The plate 10 has a light-emitting plane 11, a light-reflecting plane 12 and a light-receiving plane 13. The light-emitting plane 11 and the light-reflecting 12 are opposite to each other. The lamp 40 is disposed facing the light-receiving plane 13 in order to emit light. The reflector 30 is adjacent to the light-reflecting plane 12. The light guide plate 10 is disposed between the liquid crystal panel 20 and the reflector 30.

As shown in FIG. 4, when the lamp 40 lights, light from the lamp 40 is incident on the light-receiving plane 13 and enters the light guide plate 10. The light is then reflected by a plurality of recesses 14 on the light-reflecting plane 12 of the light guide plate 10 to the liquid crystal panel 20 at an emitting range of ±70°. Thus, an image with viewing angle of ±70° is produced on the liquid crystal panel 20.

[Second Embodiment]

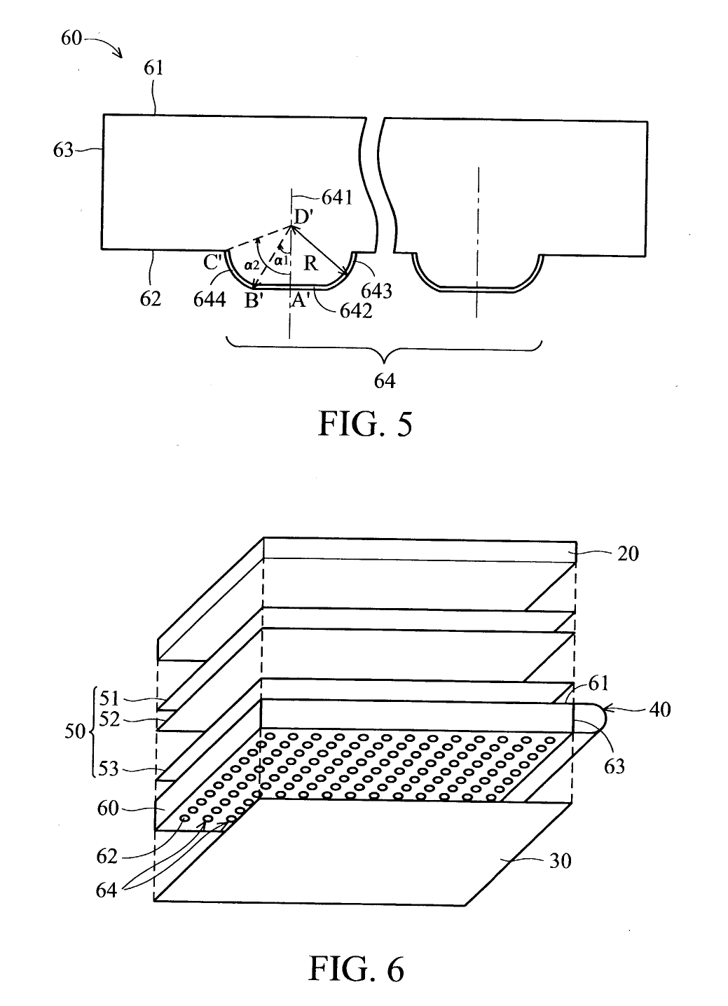

FIG. 5 is a schematic cross-section of a second embodiment of the light guide plate capable of controlling light-emitting angle according to the invention. In FIG. 5, in this embodiment, the light guide plate capable of controlling light-emitting angle 60 has a light-emitting plane 61 and a light-reflecting plane 62. Additionally, a lamp is disposed near to an end 63 of the light guide plate 60. This invention is characterized in that a plurality of reflective patterns are formed on the light-reflecting plane 62.

As shown in FIG. 5, a plurality of reflective patterns 64 is a plurality of protrusions. Each protrusion includes a main axis 641 and a circular plane 642 perpendicular to the main axis 641. Additionally, an arc from a first included angle α1 to a second included angle α2 in respect to the main axis 641 at a predetermined radius R is formed and an arc lateral plane 643 is formed by the arc around the main axis 641. An edge of the arc lateral plane 643 at the first included angle α1 is connected to an edge of the circular plane 142. Further, a reflective film 644 on the plane of each protrusion is formed over the planes 642, 643 to reflect incident light on the protrusion in a respective protrusion.

FIG. 6 shows a schematic diagram of a liquid crystal display (LCD) with the light guide plate capable of controlling light-emitting angle according to the second embodiment. In FIG. 6, the LCD includes: a liquid crystal panel 20, a light guide plate capable of controlling light-emitting angle 60, a reflector 30, and a lamp 40. Additionally, a diffusing means 50 can be located between the liquid crystal panel 20 and the light guide plate 60 as needed. The plate 60 has a light-emitting plane 61, a light-reflecting plane 62, and a light-receiving plane 63. The light-emitting plane 51 and the light-reflecting 62 are opposite to each other. The lamp 40 is disposed facing the light-receiving plane 13 in order to emit light. The reflector 30 is adjacent to the light-reflecting plane 62. The light guide plate 60 is disposed between the liquid crystal panel 20 and the reflector 30.

As shown in FIG. 6, when the lamp 40 lights, light from the lamp 40 is incident on the light-receiving plane 63 and enters the light guide plate 60. The light is then reflected by a plurality of recesses 64 on the light-reflecting plane 62 of the light guide plate 60 to the liquid crystal panel 20 at an emitting range of ±70°. Thus, an image with viewing angle of ±70°is produced on the liquid crystal panel 20.

In the present invention, a diffusing means 50 is implemented on the light-emitting plane 61 of the plate 60. The diffusing means 50 includes a diffusing sheet 51, a prism sheet 52 and a protecting film 53. The protecting film 53 is located over the light-emitting plane 61 of the plate 60. The diffusing sheet 51 is adjacent to the liquid crystal panel 20, which is on the top. The prism sheet 52 is between the sheet 51 and the film 53. Thus, the desired LCD is formed.

In the present invention, light-emitting angles of the plate 10 and 60 can be controlled by taking lamps with different light-emitting angles and changing the first and second included angles α1, α2 of the recesses or the protrusions. Thus, viewing angle of the LCD is controllable.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A light guide plate capable of controlling light-emitting angle, comprising:
a body having a light-emitting plane, a light-reflecting plane with a plurality of recesses and a light-receiving plane, each recess having:
a main axis;
a circular plane perpendicular to the main axis;
an arc lateral plane, formed by an arc from a first included angle to a second included angle in respect to the main axis at a predetermined radius surrounding the main axis, wherein an edge of the arc lateral plane is connected to an edge of the circular plane; and
a reflective film, formed over the circular plane and the arc lateral plane.

2. The light guide plate of claim 1, wherein the light-emitting angle of the light guide plate is regulated by said first included angles and said second included angles.

3. A light guide plate capable of controlling light-emitting angle, comprising:
a body having a light-emitting plane, a light-reflecting plane with a plurality of protrusions and a light-receiving plane, each protrusion having:
a main axis;
a circular plane perpendicular to the main axis;
an arc lateral plane, formed by an arc from a first included angle to a second included angle in respect to the main axis at a predetermined radius surrounding the main axis, wherein an edge of the arc lateral plane is connected to an edge of the circular plane; and
a reflective film, formed over the circular plane and the arc lateral plane.

4. The light guide plate of claim 3, wherein light-emitting angle of the light guide plate is regulated by said first included angles and second included angles.

5. A liquid crystal display device, comprising:
a light guide plate having a light-emitting plane, a light-reflecting plane with a plurality of recesses and a light-receiving plane;
a liquid crystal panel disposed adjacent to the light-emitting plane;
a reflector disposed adjacent to the light-reflecting plane; and
a lamp disposed facing the light-receiving plane in order to emit light at a predetermined angle, each recess having:
a main axis;
a circular plane perpendicular to the main axis;
an arc lateral plane, formed by an arc from a first included angle to a second included angle in respect to the main axis at a predetermined radius surrounding the main axis, wherein an edge of the arc lateral plane is connected to an edge of the circular plane; and
a reflective film, formed over the circular plane and the arc lateral plane.

6. The liquid crystal display device of claim 5, wherein light-emitting angle of the light guide plate is regulated by said first included angles and said second included angles.

7. The liquid crystal display device of claim 5, further comprising a diffusing means located between the liquid crystal panel and the light guide plate.

8. The liquid crystal display device of claim 7, wherein the diffusing means comprises a protecting film, a prism sheet and a diffusing sheet, wherein the protecting film is disposed over the light guide plate.

9. A liquid crystal display device, comprising:
a light guide plate having a light-emitting plane, a light-reflecting plane with a plurality of protrusions and a light-receiving plane;
a liquid crystal panel disposed adjacent to the light-emitting plane;
a reflector disposed adjacent to the light-reflecting plane; and
a lamp disposed facing the light-receiving plane in order to emit light at a predetermined angle, each protrusion having:
a main axis;
a circular plane perpendicular to the main axis;
an arc lateral plane, formed by an arc from a first included angle to a second included angle in respect to the main axis at a predetermined radius surrounding the main axis, wherein an edge of the arc lateral plane is connected to an edge of the circular plane; and
a reflective film, formed over the circular plane and the arc lateral plane.

10. The liquid crystal display device of claim 9, wherein light-emitting angle of the light guide plate is regulated by said first included angles and said second included angles.

11. The liquid crystal display device of claim 9, further comprising a diffusing means located between the liquid crystal panel and the light guide plate.

12. The liquid crystal display device of claim 11, wherein the diffusing means comprises a protecting film, a prism sheet and a diffusing sheet, wherein the protecting film is disposed over the light guide plate.
